(19) United States
(12) Patent Application Publication
(10) Pub. No.: US 2016/0088101 A1
(43) Pub. Date: Mar. 24, 2016

(54) SYSTEM AND METHOD FOR MONITORING VIEWED CONTENT

(71) Applicant: D2L Corporation, Kitchener (CA)

(72) Inventors: David BATISTE, Kitchener (CA); David LOCKHART, Kitchener (CA); Brian PEARSON, Kitchener (CA); Nicholas DINGLE, Kitchener (CA); Rylan COTTRELL, Kitchener (CA); Kieran ANDERSON, Kitchener (CA); Philip BROWN, Kitchener (CA)

(21) Appl. No.: 14/490,857

(22) Filed: Sep. 19, 2014

(51) Int. Cl. H04L 29/08; H04L 12/26

(52) U.S. Cl. CPC H04L 67/22; H04L 43/065; H04L 43/10; H04L 67/306

(57) ABSTRACT

A system and method for monitoring viewed content is provided. The method includes: monitoring for loading of electronic content on a user device; receiving periodic updates at a network device from the user device related to user actions associated with the electronic content; and monitoring a viewed status of the electronic content based on the user actions. The system includes: a content module configured to monitor for loading of electronic content on a user device; a tracking module configured to receive periodic updates from the user device related to user actions associated with the electronic content; and a status module configured to monitor a viewed status of the electronic content based on the user actions.

### FIELD

The present disclosure relates generally to electronic content. More particularly, the present disclosure relates to a system and method for monitoring viewed content.

### BACKGROUND

Many users of the Internet view and read pages of information when reviewing various Internet websites. Users may frequent a plurality of blogs, discussion boards, news sites, or other pages that may contain a significant amount of information and content. Users may find reviewing past Internet postings to be beneficial if a user is looking for specific material.

Developers of web sites or developers of content for web sites may also wish to know what users have reviewed, and which elements or which content was reviewed or left unread by the users. Having this information may be beneficial for the developers to understand the use of the web site. In particular, in educational situations, instructors developing course specific web sites may wish to determine what information students' review and what information has not been reviewed by the students.

It is, therefore, desirable to provide an improved method and system for monitoring viewed content.

The above information is presented as background information only to assist with an understanding of the present disclosure. No determination has been made, and no assertion is made, as to whether any of the above might be applicable as prior art with regard to the present disclosure.

### SUMMARY

In a first aspect, the present disclosure provides a method for monitoring viewed content including: monitoring for loading of electronic content on a user device; receiving periodic updates at a network device from the user device related to user actions associated with the electronic content; and monitoring a viewed status of the electronic content based on the user actions.

In a particular case, the method may further include: retrieving user conditions associated with the electronic content; and modifying the viewed status based on the user conditions.

In another particular case, the user actions may include scrolling of the electronic content within a viewing area.

In still another particular case, the electronic content may include scrolling points and the viewed status is determined based on the scrolling points.

In yet another particular case, receiving periodic updates of the user actions associated with the electronic content may include receiving periodic updates from the user device at predetermined time intervals.

In still yet another particular case, receiving periodic updates of the user actions associated with the electronic content may include receiving periodic updates from the user device on a triggering event.

In a particular case, the method may further include, determining analytics based on a user's viewing of the electronic content.

In another particular case, the method may include, aggregating the analytics over a plurality of users for the electronic content.

In yet another particular case, the method the receiving periodic updates may include: receiving whether a user is using assistive technology; and determining the assistive technology's access of the electronic content.

In another aspect, there is provided a system for monitoring viewed content, the system including: a content module configured to monitor for loading of electronic content on a user device; a tracking module configured to receive periodic updates from the user device related to user actions associated with the electronic content; and a status module configured to monitor a viewed status of the electronic content based on the user actions.

In a particular case, the system may further include, a user module configured to retrieve user conditions associated with the electronic content; and wherein the status module is further configured to modify the viewed status based on the user conditions.

In another particular case, the user actions may include scrolling of the electronic content within a viewing area.

In yet another particular case, the electronic content may include scrolling points and the viewed status is determined based on the scrolling points.

In still another particular case, the tracking module is configured to receive periodic updates of the user actions associated with the electronic content at predetermined time intervals.

In still yet another particular case, the tracking module is configured to receive periodic updates of the user actions associated with the electronic content on a triggering event.

In a particular case, the system may further include, an analytics module configured to determine analytics based on a user's viewing of the electronic content.

In another particular case, the system may further include a reporting module configured to aggregate the analytics over a plurality of users for the electronic content.

In yet another particular case, the system further includes a user tracking module configured to: determine whether a user is using assistive technology; and determine the assistive technology's access of the electronic content.

In a further embodiment, the present disclosure provides a method for monitoring viewed content in a learning management system, the method including: monitoring for loading of electronic content from the learning management system onto a student's user device; receiving periodic updates from the student's user device related to user actions associated with the electronic content; monitoring a viewed status of the electronic content based on the user actions; determining analytics based on a student's viewing of the electronic content; and aggregating the analytics over a plurality of students for the electronic content.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is an example environment for a system for monitoring viewed content according to an embodiment;

FIG. 2 illustrates a network device for a system for monitoring viewed content according to an embodiment;

FIG. 3 illustrates a user device for a system for monitoring viewed content according to an embodiment;

FIG. 4 is a flowchart of a method for monitoring viewed content according to an embodiment; and

FIG. 5 is a flowchart of a method for analyzing viewed content according to an embodiment.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for monitoring viewed content. The system is configured to monitor loaded electronic content, for example, a web page, a video, a discussion forum, a document, email, or the like, when it is loaded into a viewer on a user device. The system further tracks users' actions within the loaded electronic content and determines the status of the electronic content and, in particular, what content the user has viewed or not. The system may then determine whether there are any user conditions that may further modify the status of the content. The status of the content is stored for the user, such that, when the user re-accesses the content the user is notified as to which content the user has previously viewed.

In some cases, the method and system for monitoring viewed content may further provide analytic and reporting capabilities. In an example, the system and method may be operatively connected to a learning management system and may be used to track student viewed content. In another example, the system and method may be used by a blogger or content developer to determine the online content that is being reviewed by users, thus, allowing the blogger or content developer to design online content to the viewing of their users. The information may also be useful in determining ad feeding or placement in the content or the like.

Embodiments of the system and method detailed herein are intended to provide more accurate data on viewed electronic content. In particular, as the system and method described herein are intended to determine the content that has been viewed by the user in a detailed way, the resulting data is expected to be more accurate than basing the viewed status on other factors, for example a user just visiting a web page, a user clicking on a “viewed” button, or the like.

In particular, in conventional web measuring technologies based on a user visiting the web page or website indicating that the user has reviewed all of the electronic content of the web page or website whether or not the user has actually had all the content in a viewing area. Also, requiring user input, for example a user clicking on a “viewed” button, is based on an assumption that clicking the button means the user has read the content, which may not be a valid assumption. Further, the assumption that not clicking the button means the user has not read the material may not be valid as many users could view the content and opt not to click the corresponding button or may not even notice the button, leading to inaccurately reported data on read content.

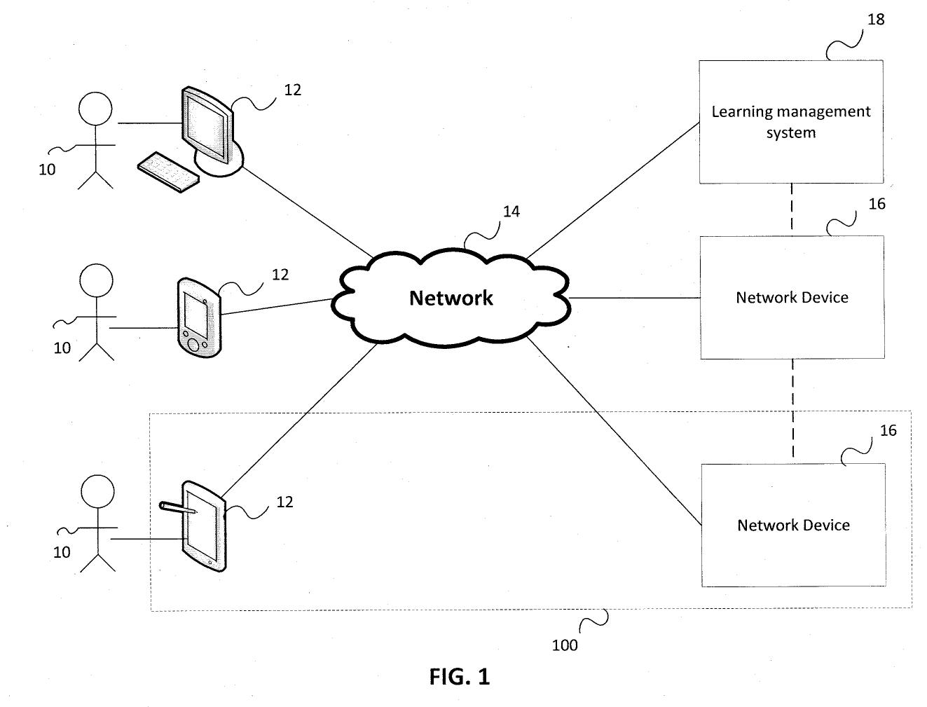

FIG. 1 illustrates an example environment for an embodiment of a system 100 for determining viewed content. Users 10 use a variety of user devices 12, for example, laptop computers, desktop computers, tablets, mobile phones, smartphones, televisions, or the like, for accessing a network 14, for example, the Internet, a Local Area Network (LAN), a Virtual Local Area Network (VLAN), a Wide Area Network (WAN), a Virtual Private Network (VPN), or the like.

Users 10 access electronic content, for example, websites, news articles, discussion boards, blogs, videos, and the like, from one or more network devices 16 via the network 14. Users 10 may also access content from a learning management system 18, for example, course material such as class specific discussion boards, assignments, articles, institution related material, student related material, or the like.

The system 100 may be partly incorporated in a network device 16 or a learning management system 18 or may be a stand-alone network device operatively connected to one or more network devices or learning management systems. The operative connection may be via a direct connection (shown in dotted lines) or via the network 14.

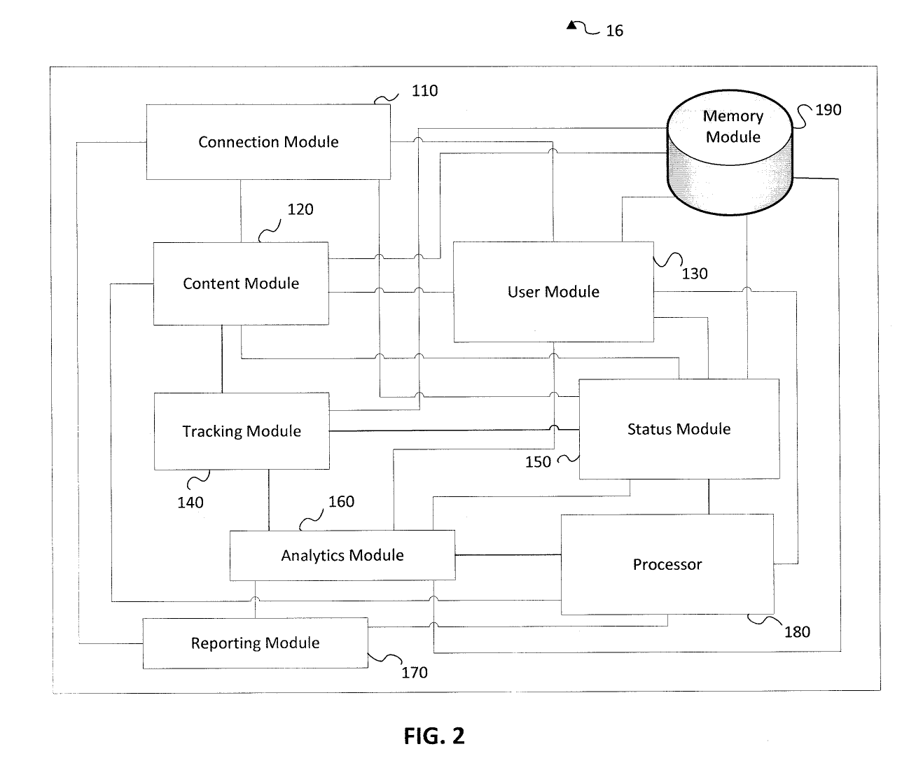

FIG. 2 illustrates an example network device for a system 100 for monitoring viewed content according to an embodiment. The network device 16 for the system 100 includes a connection module 110, a content module 120, a user module 130, a tracking module 140, a status module 150, an analytics module 160, a reporting module 170, a processor 180 and a memory module 190.

The connection module 110 is configured to receive and transmit data to and from the network 14, the network device 16, the learning management system 18 or the like. The connection module 110 may also be configured to parse the data to determine which internal module or external device or system should receive the data. In some cases, the connection module 110 will receive or intercept a request from a user, via the network, to access electronic content. In other cases, the connection module may receive or intercept data being sent to a user by the network device 16 or the learning management system 18.

The content module 110 is configured to determine the content requested by the user. The content module 110 may retrieve the content from a network device 16 or may be configured to request the network device 16 to display the content to the user, by sending a request to the network device 16 via the connection module 110. In some cases, where the system is a component of a network device 16, the content module 110 may retrieve the content from the memory module 190, which may include at least one database configured to store electronic content.

The user module 130 is configured to determine user conditions related to the user requesting the electronic content. User conditions may include, for example, a specific status request set by the user, whether the user is using assistive technology, the user's role, specific user privileges, or the like. The user module 130 may determine some user conditions by retrieving any saved user conditions form the memory module 190. The user module 130 may further query the user device 12 to determine other user conditions.

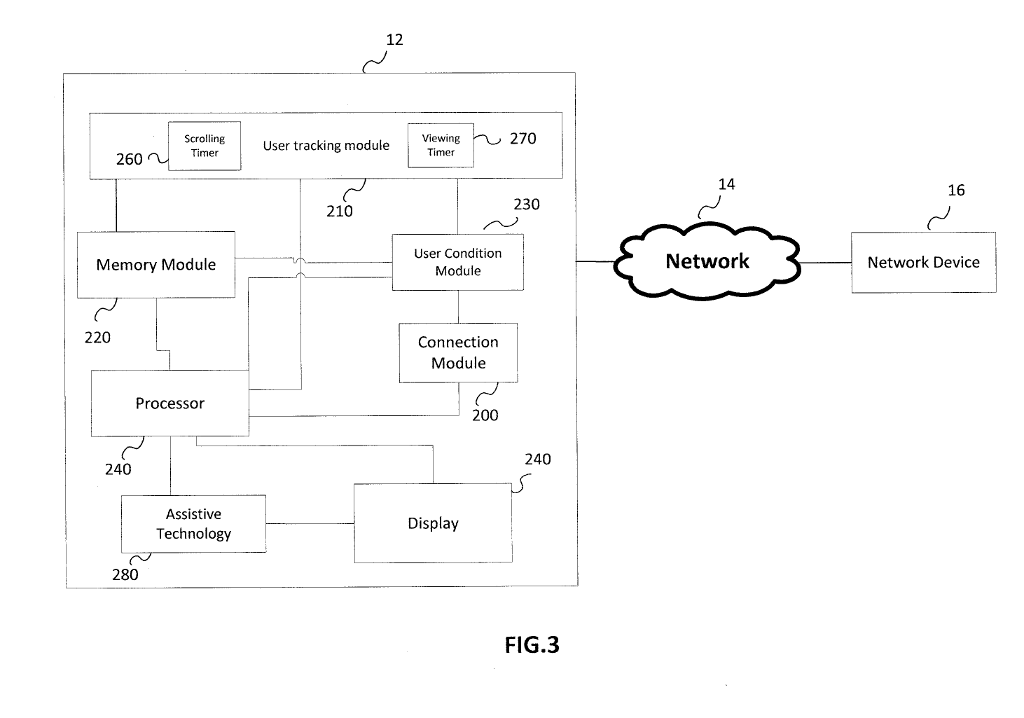

The tracking module 140 is configured to track content in a user's view finder, for example content that is displayed on the user's screen, or within a window of the user's screen which the user has currently activated, for example, by scrolling in this area. In some cases, the tracking module 140 may track the content via for example, a cookie or other element installed on the user device 12. In other cases, the system 100 includes a user tracking module 210 on the user device 12 (shown in FIG. 3) which may provide update on a user's actions in association with the content on a periodic basis.

The status module 150 is configured to determine the user status associated with the loaded electronic content based in part on the user's actions with the content tracked by the tracking module 140. The status module 150 is configured to determine whether the content has been viewed or read, partially viewed or not previously viewed based on the user's actions and any user conditions determined by the user module 130 associated with the electronic content. The status module 150 may query the memory module 190 to determine the status, or the status module 150 may include a separate and dedicated memory module or database to store user status. In other cases, the status may be stored on the user device 12 and the status module 150 may be configured to query the user device to determine the status. For example, the status of viewed or unviewed content associated with specific electronic content may be stored in, for example, a cookie, and the status module 150 may retrieve the data from the cookie to determine the content the user has viewed. The status module 150 will further update the status in association with the electronic on data received from the user module 130 and the tracking module 140.

The analytics module 160 is configured to gather analytics regarding the viewing of various elements of electronic content. The analytics module 160 is intended to gather statistics and amalgamate information related to an individual user's viewing of various pieces of electronic content or determine viewing statistics of a single piece of electronic content by a plurality of users. In some cases, the analytics module 160 may retrieve and amalgamate data from the memory module 190.

The reporting module 170 is configured to produce reports based on the data retrieved or determined by the analytics module 160. The reporting module 170 is operatively connected to the connection module 110 in order to transmit the reports to a user device 12. In some cases, the reporting module 170 may aggregate or amalgamate the data received from the analytics module 160.

The system 100 further includes the processor 180. The processor 180 is configured to execute instructions from the other modules of the system 100. In some cases, the processor may be a central processing unit. In other cases, each module may be operatively connected to a separate processor.

It will be understood that in some cases, the system 100 may be a distributed system wherein the modules may be operatively connected but may be hosted over a plurality of network devices.

FIG. 3 illustrates an embodiment of user device 12 for a system 100 for monitoring viewed content according to an example embodiment. The user device may include a connection module 200, a user tracking module 210, a user condition module 230, a memory module 220, a processor 240 and display 250. It will be understood that the user device may include other components not shown in FIG. 3, for example an input component, application components, electronic components, that may or may not be operatively connected to the system 100.

The connection module 200 is configured to transmit data to and receive data from the network 14. The connection module 200 may transmit a user's request to access electronic content and may further receive the electronic content from the system 100 or a third party server, via the network 14.

The user tracking module 210 is configured to track the user's actions or movement on the user device when viewing the electronic content. In some cases, the user tracking module 210 may track the actions, for example, scrolling on a computer, flipping or swiping on a tablet, or the like, in association with the electronic content to determine what content has been in a viewing area of the user device. The user tracking module 210 may be configured to send periodic updates, for example, on a trigger event, on a predetermined time interval, or the like, with respect to the user's actions associated with the electronic content to the tracking module 140 of the network device 16. In other cases, the user tracking module 210 may store data related to the user's actions associated with the electronic content, by for example, updating a cookie associated with the electronic content.

In some cases, the user tracking module 210 may include a scrolling timer 260 and/or a viewing timer 270. The scrolling timer 260 may start a timing the user's scrolling action when the user begins to scroll through the electronic content. If the scrolling timer 260 reaches a predetermined threshold, for example, 2 seconds, 5 seconds, 30 seconds, 1 minute, or the like, the electronic content may be marked as read or viewed while if the timer does not reach the predetermined threshold, the electronic content may be marked as unread. The viewing timer 270 is configured to time the length of time the user spends reviewing a specific component of the electronic content. The viewing timer 270 may start when the specific component enters the user's viewing area and may stop once the specific component is no longer within the user's viewing area. The time determined by the viewing timer may be stored in the memory module 220 or may be transmitted to the memory module 190 of the network device 16 in order to be queried by the analytics module 160 when determining various viewing analytics related to the electronic content.

The user device 12 further includes the memory module 220 configured to store data related to the user's actions associated with the viewed electronic content. In some cases, the memory module 220 may be a memory module for the user device and may store data related to the operation and applications of the user device 12. In other cases, the memory module 220 may be a dedicated memory module for the user tracking module 210.

The user condition module 230 is configured to determine user conditions, for example, user request, user role, user device status, or the like, that may alter the current status of the content. In some cases, the user condition module 230 may update a cookie associated with the electronic content. In other cases, the user condition module 230 may send the user conditions to the user module 130 on the network device 16.

The processor 240 may be a central processing unit for the user device 12 or may be a separate processing unit to be used in conjunction with the user device module of the system.

The display 250 is configured to display electronic content to the user. The display 250 may be, for example, a screen, a monitor, or the like. The display 250 may include a single viewing area, or may be configured to display nested viewing areas, for example, rendering videos or documents within a web page.

The user device may further include assistive technology 280, for example screen readers. The assistive technology 280 is intended to be configured to read or otherwise provide the user with details of the electronic content. It will be understood that the assistive technology 280 may not be part of the system 100 but may interact with the system 100. For example, user's actions may include instructions to the assistive technology 280 to read content to the user. In some cases, when referring to material within the viewing area of the user, the viewing area may include the area reviewed by the assistive technology 280, whether or not in the display 250 of the user device 12.

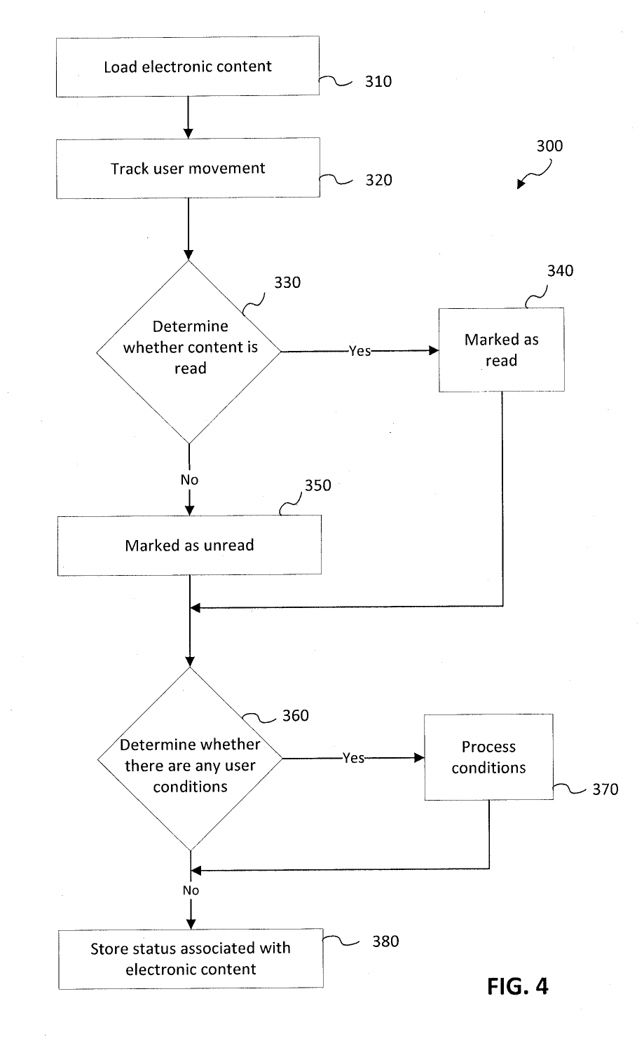

FIG. 4 illustrates an embodiment of a method 300 for determining viewed content. The connection module 110 receives a request for electronic content, from the connection module 200 of the user device.

At 310, the content module 120 receives or intercepts the electronic content requested by the user device 12 to be loaded on a viewer of the user device 12.

In some cases, the content module 120 may query the status module 150 to determine the status of the content to be loaded, prior to transmitting the content to the user device 12. The content module 120 may retrieve data that provides information as to what, if any, of the electronic content has been previously viewed by the user requesting the material. The content module 120 may ensure that the status of the content is transmitted when the content is transmitted to the user device 12.

In some cases, the content module 120 may ensure that, when the content is loaded, any previously viewed content is noted and content that is either new since the last time the user has accessed the content is in a viewing area, for example, a view finder, a view port, or the like, of the user device 12, otherwise the content the user has not read, for example, where the user ceased viewing the content, is displayed in the viewing area.

In other cases, the content module 120 may query data stored in the user device, for example a cookie stored in the memory module 220 to determine the electronic content that has been previously viewed and is associated with the requested content.

At 320, the tracking module 130 tracks user's actions of the electronic content in the viewing area, by for example, receiving updates from the user tracking module 210, by querying a cookie or other device data, or the like. By determining whether the user is scrolling the content, the tracking module 130 determines what content the user has viewed.

In some cases, the user tracking module 210 of the user device 12 is configured to track the user's actions and to forward updates, via the connection module 200 to the tracking module 130 of the content viewed by the user since the previous update. The updates may be transmitted, for example, every second, every 5 seconds, every 30 seconds, every minute, or the like, or may be transmitted based on a triggering event, for example, on a request to load new content, on a user reaching a scroll point, on a user exiting the content, on a user requesting to close the network connection, or the like.

In other cases, the tracking module 130 may query a cookie or other user device data to determine the user's actions with respect to the electronic content. In this case, the user tracking module 210 may be configured to update the cookie or other device data on a regular interval, for example every second, every 5 seconds or the like, or may be configured to update the cookie or other device data on a triggering event. It is intended by having a module on the user device update the user's actions and store the user movement on the user device, network traffic and server memory space may be reduced as oppose to having the server frequently query the user device via the network.

In still other cases, the user may employ assistive technology 280, for example a screen reader or the like, and the user tracking module 210 may query the assistive technology 280 to track user's actions and update the tracking module 130 with data accessed by the assistive technology 280.

At 330, the status module 150 determines the status of the content in the viewing area, or the content loaded for review of the user. In some cases, if the tracking module 130 determines the content has been viewed by the user, the status module 150 will determine the content as “read” and if the user has stopped viewing content, for example the user's actions have ceased or the user has left the previously loaded page, content that did not reach the viewing area may have a status of “unread”.

In other cases, the system 100 may include the scrolling timer 260 and the content may be marked as read. The scrolling timer 260 may be associated with a user device 12 and the processor 230 may be configured to start and stop the scrolling timer on instructions from the user tracking module 210. If the scrolling timer 260 reaches a predetermined threshold, the content may be marked as read otherwise, if the content in the viewing area changes prior to the timer reaching the predetermined threshold, for example, 1 second, 5 seconds, 30 seconds, 1 minute, or the like, the content remains as unread. This approach may be used in cases, where scrolling through material quickly is common, but may not necessarily imply that the content is being viewed by the user.

In still other cases, the system 100 may include a viewing timer 270 which times the length of time the user spends reviewing a specific component of the electronic content. The viewing timer 270 may track the user's time spent on various components of the electronic content. The viewing timer 270 may be triggered by the user tracking module 210 and the status module 150 may query data related to the viewing timer from the user device. The viewing timer 270 may be used by the analytics module 160 when determining various viewing analytics related to the electronic content, for example, the average time a plurality of users spend reviewing the specific component of the electronic content, or the like.

At 340, the status module 150 marks the content as read. It will be understood that the status module 150 may mark the content in a similar fashion by marking the content as “reviewed”, “viewed”, “seen”, or other qualifying term that will express to the user that the content has previously been in the viewing area.

At 350, the status module 150 will mark the content as unread. Again, similar terminology may be employed instead of “unread” to convey to the user that the content has not been in the viewing area, or not in the viewing area for a predetermined threshold of time.

In the case where the user is using assistive technology 280, “read” content may be content that has been modified or accessed by the assistive technology 280 or transmitted by the accessibility technology in such a manner as to be labelled reviewed by the user, whether or not the content has actually been located in the viewing area of the user's device display.

At 360, the status module 150 determines whether there are any user conditions, for example, user request, user role, user device status, or the like, that may alter the current status of the content. In some cases, the status module 150 may query the user module 130 to determine if there are any predetermined conditions in relation to the content and the user, for example, the user may have requested that a certain document appear unread even if the document has been viewed in the viewing area. In other cases, the user may have requested to mark content from a certain webpage, discussion board, or the like as read, even if the user has not reviewed all the content in the viewing area.

At 370, after reviewing the user conditions, the status module 150 process any user condition that may further modify the status of the content.

At 380, the status module 150 stores the status associated with the electronic content. In some cases, the status may be stored in the memory module 190. In other cases, the status module 150 may include a database component and the status may be stored in the database. In still other cases, the status module 150 may modify a cookie associated with the electronic content, the cookie may reside on the user device 12 and be stored by the memory module 220.

In an example, a student may log into a learning management system 18 which may be operatively connected to a system 100 for monitoring viewed content. The student accesses content, for example a course web page. The content will be transmitted to the user device and may be transmitted with associated status data to allow previously viewed or read data to be marked. In some cases, when rendering the content to be displayed, content that has the status of previously viewed may not be rendered in the viewing area, and the displayed content will be content that has the status of unread or not previously viewed.

Once the content is transmitted to the user device and displayed by the user device's display, the user tracking module 210 will begin to track the students actions, for example the movements in the viewing area of the display. The user tracking module 210 may store the student's actions in the memory module 220 or may transmit the movements on periodic intervals, for example a predetermined time interval, a triggering event.

In some cases, the electronic content may be created or may include the addition of scrolling points, points or locations within the electronic content that may track whether the user has scrolled to or past the point in the electronic content. Each time the user tracking module 210 determines the user actions have passed by another scrolling point within the electronic document, the user tracking module 210 may send an update with respect to the user actions to the tracking module 140.

In other cases, the user tracking module 210 may determine that an event when the student begins to scroll through the course web page. The second event may be retrieved when the student ceases to scroll through the material.

Content that has been rendered in the viewing area will be marked with the status as read by that student. In some cases, viewing data may be recorded, for example the time and date the student accessed the material, the length of time the student reviewed the material, the number of times the student reviewed the material, or the like.

When the student ceases to review the electronic content by, for example, ceasing movement through the content, requesting new content, exiting the current content, or the like, the status module 150 will determine which content may be marked as read and which content may remain (or be marked as) unread. The status module 150 may further review user conditions, for example whether the student has manually set the status of the electronic content, and may update the status based on the user conditions.

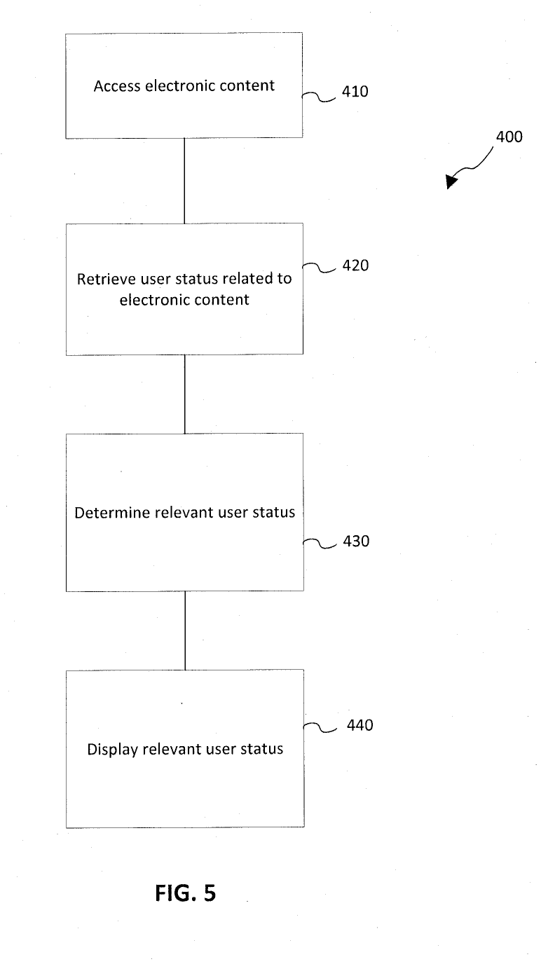

FIG. 5 illustrates a method 400 for analyzing viewed content according to an embodiment.

At 410, a user accesses electronic content, for example, an instructor accessing a course website, an administrator accessing a discussion board, a user accessing a news website, or the like. In some cases, the user may be accessing information from the learning management system 18 or from another internal system and the user may have previously logged into the internal system.

On accessing the electronic content, the user may further request to access analytics related to the electronic content. In some cases, the analytics may be restricted to a class of users, for example in the learning management system 18 analytics may be restricted to instructors or course administrators. In other cases, the analytics accessible to the user may vary depending on the user's role, for example, an instructor may be able to gather analytics on courses the instructor teaches, an administrator may be able to gather analytics on everyone within an institution, a student may be limited to reviewing analytics about their own use, a teaching assistant may be able to review analytics about students the teaching assistant supervises, or the like.

At 420, the analytics module 160 retrieves relevant user status associated with the accessed electronic content. The analytics module 160 may query the relevant user status from, for example the memory module 190, a separate database associated with the user module 130, or the like.

At 430, the analytics module 160 determines relevant user statuses to report to the user accessing the analytics. In some cases, the relevant user statuses may be determined by the user conditions, for example, the user's role. Depending on the user's role, the user may receive specific analytics that are intended to be of interest to the user. In other cases, the user may be able to specify various analytics the user's wishes to review.

At 440, the relevant analytics are displayed to the user. It is intended that after the analytics module 160 determines the relevant analytics, the analytics module 160 may transmit the relevant analytics to the reporting module 170 to display the analytics. In some cases, the reporting module 170 may aggregate the analytics, for example, providing a percentage of user's that have reviewed or read specific electronic content. In other cases, the user may request specific aggregations and the reporting module 170 may determine the report based on user input.

In some cases, the relevant analytics may relate to the viewing time of specific content with the electronic content. For example, an instructor may wish to know how long a student spent reviewing an assignment or may wish to know the average time students within a specific class spent reviewing the assignment. The memory module 190 may store results as to how long each user spent reviewing the assignment after receiving the data from each user device tracked by the viewing timer 270.

In some cases, the system 100 may be used when a user is accessing discussion boards or discussion forums. The user, on accessing the discussion forum, may be clearly shown which entries the user has read or reviewed and which are yet to be reviewed. Where the discussion board contains a plurality of threads and a plurality of responses per each thread, the user may be shown which discussions have not been reviewed at all and which discussions have been reviewed but still contain unviewed responses and which discussions have been reviewed in their entirety.

In some cases, this information may be displayed in a column format next to the discussion topic. The user may be shown a discussion topic in each row, with the number of entries in a following column and the number of read entries in a third column. In other cases, the discussion topic may appear in one color for previously read discussion, another color for discussions that are partly read and a third color for unread discussions. Other visual cues may be used which are intended to distinguish between the status of the posts on the discussion boards.

The system 100 may further provide a user with an option to mark certain content as read or unread, whether or not the user has reviewed the content. For example, in a discussion board or discussion forum, the user may select to mark all posts as read or all posts within a specific thread as read, whether or not the user has reviewed the content. It is intended that once the status is marked as read, on subsequent requests for the content, the content will be displayed as read.

The user may also select to mark all posts or a particular post as unread, even after the user has viewed the content. It may be configured such that the selected content will maintain a status of unread, even if the user tracking module 210 or the tracking module 140 determine that the user movements imply the content has been subsequently reviewed. In some cases, content that has been marked as unread, may remain in this status until a subsequent user session, for example, a user logging out and logging back into the system, a user leaving the website and returning to the website, or the like, or user request to review the material after a predetermined passage of time, for example 1 hour, 1 day, 1 week, or the like. In other cases, the status of the content may remain unread until the user manually changes the status to a read or reviewed status.

The system 100 is configured to amend the status of electronic content on a deletion of any content or an element or section of the content. In a particular example, if the content being accessed by the user is a discussion forum and the display shows the number of entries and read entries in a thread in a table format, on deletion of an element within the thread, the system 100 is configured to determine whether the element deleted had been previously read by the user, and if so, decrease both the number or read entries and total entries by one. If, on the other hand, the deleted element was previously unread, than the system 100 may be configured to amend the total number of entries but leave the number of read entries unchanged.

The system 100 may be further configured to display user written content as previously viewed or read content. In a particular example, the user may respond to an entry on a discussion forum. On submitting the response, the system 100 determines that the response is a viewed or read entry as it is assumed that the user has viewed the response by creating it.

In some cases, system 100 may be configured to differentiate between user triggered scrolling and a user device triggered scrolling. In a particular example, when loading a second web page of a multiple page website, after scrolling to the bottom of the first page, the user device may load the page and determine that the top of the page is not in the viewing area and scroll the page to ensure the viewing area includes the top of the page. In this case, the tracking module 140 and user tracking module 210 are configured to determine this movement as an automatic movement that is unrelated to the determining user movement through the electronic content. The status module 150 is configured to allow the status of the electronic content to remain the same, even if the content has been included within the viewing area. Once the user begins interaction with the electronic document via user actions, the tracking module 140 and user tracking module 210 will monitor the user actions and the status module 150 will update the status accordingly.

In a particular example, when the system 100 is operatively connected to a learning management system, and the requested content is a large file, for example a course assignment, a business case, a paper, a pre-recorded lecture (audio or video), or the like, the content may include scroll points. Scroll points are intended to allow a user, for example a student, to view or read a portion of the document, and the status of the document may be updated, when the user tracking module 210 determines the user has viewed the document past a scroll point, for example, by having a scroll point move into the viewing area or move out of the viewing area, the user tracking module 210 may determine this movement as a triggering event and transmit the data to the tracking module 140 to update the tracking status of the content. If the student subsequently ceases reviewing the content, the status of the content may be partially reviewed and if the student returns to the content, the student may be directed to the first unread or unviewed scroll point. This is intended to save the student time when re-accessing the material as the student will be directed to unread content and not be required to scroll through previously reviewed content.

In some cases, the content module 120 may be configured to insert scroll points into electronic content. For example, the content module 120 may determine the electronic document is a video lecture, and may include a scroll point at predetermined intervals, for example every minute, every 5 minutes, every 10 minutes, or the like. The predetermined intervals may be amended or may be dependent on the original length of the video.

In other cases, the developer of the content may manually insert scroll points within the electronic content. For example, if an instructor is developing a business case for a course web page, the instructor may insert scroll points within the electronic content. Once a student reviewing the business case passes a scroll point, the status of the electronic content may be updated.

The system 100 may further be configured to determine the status of various nested electronic content. For example, in a learning management system, a course website may include an overall page with nested elements, for example, documents, videos, images, or the like, and the system 100 may include a status for each element within the electronic content and contain a status for the nested elements of the electronic content.

In a particular example, the user device may be a tablet or other touch screen device. The user tracking module 210 may track user actions via user interactions with the touch screen, for example, the user movement may be swiping through the content and a triggering event may be the beginning of the swiping motion or the flip and the end of the user action may be determined by where the electronic document stops on the user device. In some cases, the system 100 may determine that the content that has been flipped or swiped through as read. In other cases, the system 100 may determine the time associated with the user movements, and if the time does not reach a predetermined time threshold, the content may be considered unread and if the time reaches or exceeds the predetermined time threshold, then the system may set the status as read.

In another particular example, the user device may include assistive technology 280. The user tracking module 210 may be adapted to determine content accessed by the assistive technology 280 and to track assistive technology actions as opposed to user actions. If, for example, the assistive technology 280 is a screen reader, the content may not be scrolled or enter a viewing area for the user to have reviewed the content. As such, the user tracking module 210 queries the assistive technology 280 or receives updates from the assistive technology 280 to determine which content has been reviewed by the user.

In still another particular example, the system may be incorporated with a learning management system and may provide an instructor with an ability to track user involvement with respect to electronic content related to or associated with the instructors' class. The analytics module 160 may track student analytics, for example, which students have accessed which electronic content, when the content was accessed, how long the content was accessed, or the like. The reporting module 170 may report the student analytics to the instructor on specific students and the student's access to the electronic content. It is intended that this information may be beneficial to the instructor to determine which students are actively engaged in reviewing the electronic content provided by the instructor and which students are not viewing the electronic content. In some cases, the time and length of the student's first access of the content may be recorded and may remain stored in a memory module, even if the student then changes or returns the status of the content to unread. It is intended that this will allow the student to maintain the desired status of the content but also allow the instructor to receive accurate information as to which students have viewed the content.

In some cases, the reporting module 170 may aggregate the analytics. For example, the instructor may wish to know the average time students spent reviewing a particular piece of electronic content, or the average number of students who are reviewing the discussion board per section of the course. In some cases, the system 100 may include a graphical user interface where the instructor may request specific aggregated data related to the stored data. Reviewing aggregated data may provide the instructor feedback as to which elements or content are being reviewed and which other content is being ignored or overlooked. The aggregated analytics may also provide the instructor an indication if a particular element within the electronic content is providing students with difficulty, for example, if the average student time spent on, for example, a particular question is an assignment, a particular page in a case study, or the like is significantly higher than the average time in other comparable areas, the aggregated analytics may indicate that the particular element may not be understood or may be difficult to understand by the students, on average.

It is intended that the system 100 stores the status of the viewed electronic content associated with users. This is intended to allow users to access the content on a plurality of user devices and maintain the desired status over the plurality of devices.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for monitoring viewed content comprising:
monitoring for loading of electronic content on a user device;
receiving periodic updates at a network device from the user device related to user actions associated with the electronic content; and
monitoring a viewed status of the electronic content based on the user actions.

2. The method of claim 1 further comprising:
retrieving user conditions associated with the electronic content; and
modifying the viewed status based on the user conditions.

3. The method of claim 1 wherein the user action comprises scrolling of the electronic content within a viewing area.

4. The method of claim 1 wherein the electronic content comprises scrolling points and the viewed status is determined based on the scrolling points.

5. The method of claim 1 wherein the receiving periodic updates of the user actions associated with the electronic content comprises:
receiving periodic updates from the user device at predetermined time intervals.

6. The method of claim 1 wherein the receiving periodic updates of the user actions associated with the electronic content comprises:
receiving periodic updates from the user device on a triggering event.

7. The method of claim 1 further comprising:
determining analytics based on a user's viewing of the electronic content.

8. The method of claim 7 further comprising:
aggregating the analytics over a plurality of users for the electronic content.

9. The method of claim 1 wherein the receiving periodic updates comprises:
receiving whether a user is using assistive technology; and
determining the assistive technology's access of the electronic content.

10. A system for monitoring viewed content comprising:
a content module configured to monitor for loading of electronic content on a user device;
a tracking module configured to receive periodic updates from the user device related to user actions associated with the electronic content; and
a status module configured to monitor a viewed status of the electronic content based on the user actions.

11. The system of claim 10 further comprising:
a user module configured to retrieve user conditions associated with the electronic content; and
wherein the status module is further configured to modify the viewed status based on the user conditions.

12. The system of claim 10 wherein the user action comprises scrolling of the electronic content within a viewing area.

13. The system of claim 10 wherein the electronic content comprises scrolling points and the viewed status is determined based on the scrolling points.

14. The system of claim 10 wherein the tracking module is configured to receive periodic updates of the user actions associated with the electronic content at predetermined time intervals.

15. The system of claim 10 wherein the tracking module is configured to receive periodic updates of the user actions associated with the electronic content on a triggering event.

16. The system of claim 10 further comprising:
an analytics module configured to determine analytics based on a user's viewing of the electronic content.

17. The system of claim 16 further comprising:
a reporting module configured to aggregate the analytics over a plurality of users for the electronic content.

18. The system of claim 10 wherein the system further includes a user tracking module configured to:
determine whether a user is using assistive technology; and
determine the assistive technology's access of the electronic content.

19. A method for monitoring viewed content in a learning management system, the method comprising:
monitoring for loading of electronic content from the learning management system onto a student's user device;
receiving periodic updates from the student's user device related to user actions associated with the electronic content;
monitoring a viewed status of the electronic content based on the user actions;
determining analytics based on a student's viewing of the electronic content; and
aggregating the analytics over a plurality of students for the electronic content.
